(19) United States
(12) Patent Application Publication
(10) Pub. No.: US 2014/0125063 A1
(43) Pub. Date: May 8, 2014

(54) Electrical Generator

(71) Applicants: Mohammad Shahamat, Rockton, IL (US); John F. Bangura, Rockton, IL (US)

(72) Inventors: Mohammad Shahamat, Rockton, IL (US); John F. Bangura, Rockton, IL (US)

(21) Appl. No.: 13/668,707

(22) Filed: Nov. 5, 2012

(51) Int. Cl. H02K 1/27; H02K 15/03; F03D 9/00

(52) U.S. Cl. 290/55; 310/156.08; 29/596

(57) ABSTRACT

Disclosed is a generator including an inner stator including an inner stator winding, an outer stator including an outer stator winding and a rotor disposed between the inner stator and the outer stator. The rotor includes a first set of permanent magnets disposed axially, the first set of permanent magnets having a first polarity and a second set of permanent magnets disposed axially, the second set of permanent magnets having a second polarity that is opposite of the first polarity, wherein the first and second sets of permanent magnets are arranged circumferentially in alternating fashion.

### BACKGROUND OF THE INVENTION

Exemplary embodiments pertain to the art of electrical machines and more specifically to generators.

Rotating machines, such as wind turbines or gas turbines, convert kinetic energy into mechanical power, where the mechanical power may be used to drive an input, such as a generator input. In the case of a generator input, the mechanical power is converted to electrical power. The size and weight of these rotating machines are metrics that have significant impacts on electrical power generation capability, efficiency, manufacturing costs, and cost of ownership over a period of time. Generator efficiency is critical to improving electrical power production from the mechanical power. In some cases of generators, electrical power is generated by moving a rotor relative to a stator assembly, where the rotor includes permanent magnets. One factor affecting efficiency of these generators is the weight of the rotors, where an increased weight causes increased resistance to rotor movement, therefore resulting in reduced electrical power production.

In the case of wind power generation, the high power rating comes with a large size. Reducing the size of the generator can reduce the transportation and installation cost of these machines.

### BRIEF DESCRIPTION OF THE INVENTION

Disclosed is a generator including an inner stator including an inner stator winding, an outer stator including an outer stator winding and a rotor disposed between the inner stator and the outer stator. The rotor includes a first set of permanent magnets disposed axially, the first set of permanent magnets having a first polarity and a second set of permanent magnets disposed axially, the second set of permanent magnets having a second polarity that is opposite of the first polarity, wherein the first and second sets of permanent magnets are arranged circumferentially in alternating fashion.

Also disclosed is a method for assembling a generator, the method including providing an inner stator including an inner stator winding, providing an outer stator including an outer stator winding, where the outer stator is disposed radially outside the inner stator and positioning a rotor between the inner stator and the outer stator. The rotor includes a first set of permanent magnets disposed axially, the first set of permanent magnets having a first polarity and a second set of permanent magnets disposed axially, the second set of permanent magnets having a second polarity that is opposite of the first polarity, wherein the first and second sets of permanent magnets are arranged circumferentially in alternating fashion.

### BRIEF DESCRIPTION OF THE DRAWINGS

The following descriptions should not be considered limiting in any way. With reference to the accompanying drawings, like elements are numbered alike:

FIG. 1 is a sectional view of a portion of a generator according to an embodiment; and

FIG. 2 is a detailed section view of a portion of the generator from FIG. 1, including a rotor wheel, according to an embodiment.

### DETAILED DESCRIPTION OF THE INVENTION

A detailed description of one or more embodiments of the disclosed apparatus and method are presented herein by way of exemplification and not limitation with reference to the Figures.

As used herein, the term “radial” refers to movement or position perpendicular to a rotational axis or center line. It may be useful to describe parts that are at differing radial positions with regard to an axis. In this case, if a first component resides closer to the axis than a second component, it may be stated herein that the first component is “radially inward” of the second component. If, on the other hand, the first component resides further from the axis than the second component, it can be stated herein that the first component is “radially outward” or “outboard” of the second component. The term “axial” refers to movement or position parallel to an axis. Finally, the term “circumferential” refers to movement or position around an axis. Although the following discussion primarily focuses on generators in wind turbines, the concepts discussed are not limited to wind turbines and may apply to any suitable rotating machinery.

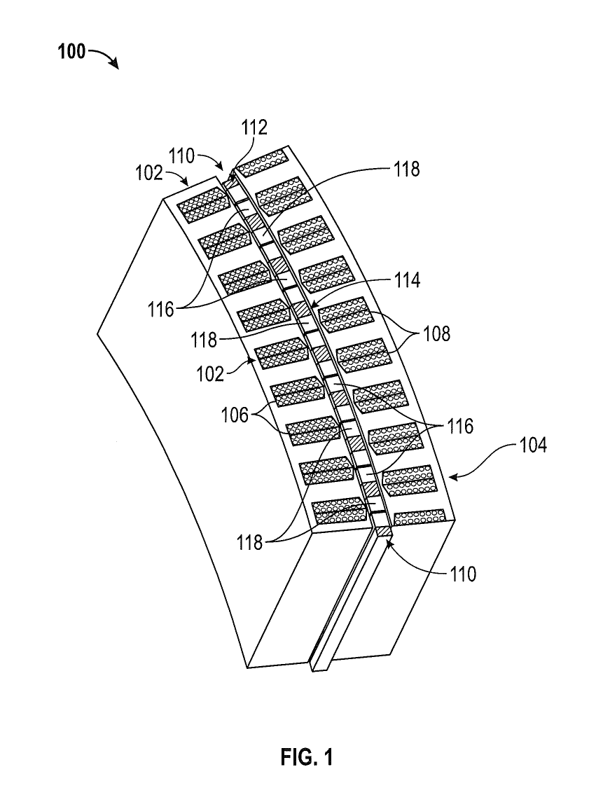

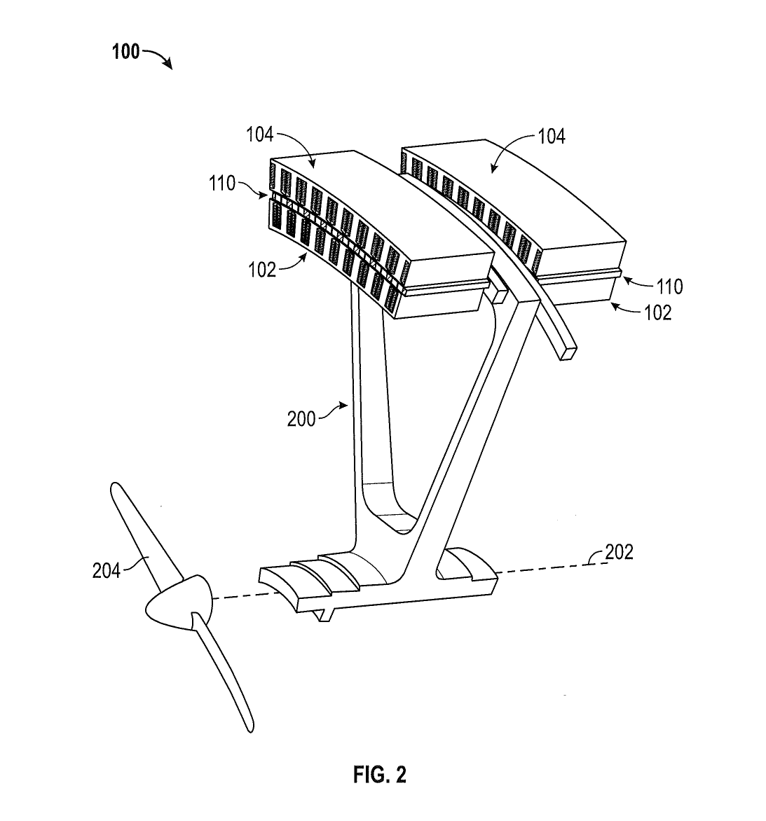

FIG. 1 is a sectional view of a portion of a generator 100, such as a permanent magnet (PM) generator, according to an embodiment. The generator 100 may be a portion of a wind turbine, where the generator converts rotational mechanical energy into electrical energy. The generator 100 includes an inner stator 102 and an outer stator 104, where movement of a rotor 110 relative to the inner stator 102 and outer stator 104 generates electrical power. As depicted, the inner stator 102 includes windings 106 while the outer stator 104 includes windings 108. In an embodiment, the inner stator 102 and outer stator 104 are each mounted to a stationary frame, while the rotor 110 is disposed on a wheel and configured to rotate about an axis of the generator 100 (shown below in FIG. 2). The depicted generator portion is a “pie slice” portion of the generator 100 having a generally cylindrical shape.

In an embodiment, the rotor 110 includes a row of permanent magnets (PMs) 112 disposed radially (with respect to the generator axis) in the rotor 110. The PMs 112 include a first set of PMs 116 and a second set of PMs 118, where the first set of PMs 116 have a polarity (e.g., positive or negative) opposite a polarity of the second set of PMs 118. A support structure 114 located between the sets of PMs, is also located in the rotor 110 to provide support for the PMs 112. The support structure 114 may be any suitable support structure, such as steel bars or a laminated structure. As depicted, the PMs 112 are disposed and arranged circumferentially lengthwise (parallel to a rotational axis of the rotor 110) in an alternating fashion, where a PM member in the first set of PMs 116 is placed next to a member of the support structure 114 and a PM member in the second set of PMs 118 is placed adjacent that support member. Thus, in an embodiment, PM member of a positive polarity is to an axial support member that is also next to PM member of a negative polarity, where the members are radially arranged in a single layer in the generator 100 assembly.

In one embodiment, the rotor 110 includes a single row of PMs of alternating polarity, where the rotor does not include a hub. The generator 100 has a reduced number of components as compared to other generator assemblies with a plurality of PM rows with a row of PM disposed on each side of a rotor hub. Therefore, the reduced amount of components in the rotor 110 provides less mass in the rotor 110, thus allowing the rotor 110 to be driven by less mechanical energy than higher mass rotor assemblies. By driving the rotor 110 with reduced mechanical energy, the electrical power output of the generator 100 is increased as compared to systems with two or more rows of magnets disposed on a rotor hub. Further, fewer rotor 100 components provides for simplified manufacturing and reduced costs.

In an embodiment, movement of airfoils or blades in a wind turbine drives rotational movement of the rotor 110. As the rotor 110 rotates about the generator 100 axis, the movement of PMs 112 relative to the stationary windings 106 and 108 cause magnetic flux to extend radially from the inner stator 102, through a positive PM member (e.g., from the first set of PMs 116) in rotor 110, to the outer stator 104, back through a negative PM member (e.g., from the second set of PMs 118) and back to the inner stator 102. The magnetic flux causes electrical power to flow in the windings 106, 108 of the inner and outer stators 102, 104. In embodiments, circumferential gaps or spacing on each side of the rotor 110 enable rotor movement within the stator structure (i.e., stators 102 and 104) without frictional resistance.

FIG. 2 is a detailed section view of a portion of the generator 100 including a rotor wheel 200 according to an embodiment. As depicted, the generator 100 is disposed about a generator axis 202, where the rotor wheel 200 and rotor 110 rotate about the generator axis 202 during operation of the generator 100. In an embodiment, the rotor 110 is coupled to a plurality of blades 204 of a wind turbine, where movement of the blades 204 causes rotation of the rotor 110 and generation of electrical power.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A generator comprising:
an inner stator including an inner stator winding;
an outer stator including an outer stator winding; and
a rotor disposed at least partially between both inner stator and the outer stator, the rotor comprising:
a first set of permanent magnets disposed radially about an axis of rotation of the rotor, the first set of permanent magnets having a first polarity; and
a second set of permanent magnets disposed radially about the axis of rotation of the rotor, the second set of permanent magnets having a second polarity that is opposite of the first polarity;
wherein the first and second sets of permanent magnets are arranged circumferentially in alternating fashion: and
wherein the first and second sets of permanent magnets are arranged in a single magnet layer; and
wherein the rotor is configured to generate a flux that extends from the outer stator, through the first set of permanent magnets, through the inner stator, through the second set of permanent magnets and back to the outer stator.

2. (canceled)

3. (canceled)

4. The generator of claim 1, wherein the rotor further comprises a support structure configured to provide support to the first and second sets of permanent magnets.

5. The generator of claim 4, wherein the support structure comprises a plurality of bars disposed between each permanent magnet of the alternating first and second sets of permanent magnets.

6. The generator of claim 5, wherein the plurality of bars comprise steel bars.

7. The generator of claim 4, wherein the support structure comprises a laminated structure.

8. (canceled)

9. A method for assembling a generator, the method comprising:
providing an inner stator including an inner stator winding;
providing an outer stator including an outer stator winding, where the outer stator is disposed radially outside the inner stator; and
positioning a portion of a rotor between the inner stator and the outer stator, the portion of the rotor comprising:
a first set of permanent magnets disposed radially about an axis of rotation of the rotor, the first set of permanent magnets having a first polarity; and
a second set of permanent magnets disposed radially about the axis of rotation of the rotor, the second set of permanent magnets having a second polarity that is opposite of the first polarity, wherein the first and second sets of permanent magnets are arranged circumferentially in alternating fashion: and
wherein the first and second sets of permanent magnets are arranged in a single magnet layer; and
wherein positioning the rotor comprises positioning a rotor configured to generate a flux that extends from the outer stator, through the first set of permanent magnets, through the inner stator, through the second set of permanent magnets and back to the outer stator.

10. (canceled)

11. (canceled)

12. The method of claim 9, wherein positioning the rotor comprises positioning a rotor comprising a support structure configured to provide support to the first and second sets of permanent magnets.

13. The method of claim 12, wherein the support structure comprises a plurality of bars disposed between each permanent magnet of the alternating first and second sets of permanent magnets.

14. The method of claim 13, wherein the plurality of bars comprise steel bars.

15. (canceled)

16. A wind turbine comprising:
a rotor;
one or more blades coupled to the rotor;
a generator comprising:
an inner stator including an inner stator winding;
an outer stator including an outer stator winding;
a first set of permanent magnets disposed radially about an axis of rotation of the rotor, the first set of permanent magnets having a first polarity; and
a second set of permanent magnets disposed radially about an axis of rotation of the rotor, the second set of permanent magnets having a second polarity that is opposite of the first polarity, wherein the first and second sets of permanent magnets are arranged circumferentially in alternating fashion; and
wherein the first and second magnets are coupled to the rotor and disposed between and inner and outer stators: and
wherein the first and second sets of permanent magnets are arranged in a single magnet layer; and
wherein the rotor is configured to generate a flux that extends, in the following sequence: from the outer stator, through the first set of permanent magnets, through the inner stator, through the second set of permanent magnets and back to the outer stator.

17. (canceled)

18. (canceled)

19. The wind turbine of claim 16, wherein the rotor further comprises a support structure configured to provide support to the first and second sets of permanent magnets.

20. The wind turbine of claim 19, wherein the support structure comprises a plurality of bars disposed between each permanent magnet of the alternating first and second sets of permanent magnets.
